(19) United States
(12) Patent Application Publication
(10) Pub. No.: US 2014/0222909 A1
(43) Pub. Date: Aug. 7, 2014

(54) Methods and systems for pairing rivals in a social network.

(71) Applicant: PAUPT LABS LLC, Mount Kisco, NY (US)

(72) Inventors: Daniel Alexander Ford, Mount Kisco, NY (US); Caldwell Martin Toll, II, Chappaqua, NY (US)

(73) Assignee: PAUPT LABS LLC, Mount Kisco, NY (US)

(21) Appl. No.: 13/758,668

(22) Filed: Feb. 4, 2013

(51) Int. Cl. H04L 29/08

(52) U.S. Cl. CPC H04L 67/22
USPC 709/204

(57) ABSTRACT

A method, system and computer program for operating a social network. The method may include generating and recording social rival relationships.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The field of the invention is the management of the interaction between individuals or entities who are connected by one or more common relationships, interests, dislikes, or social interaction.

2. Description

In a social networking system, the element of self promotion is often a strong component of the value the social network provides to attract its members. A social network often serves as a platform for advertising the achievements, no matter how small or trivial they may seem, of its members; one need only reference the banal postings of Twitter™ and Facebook™ members as they alert the world to the cup of coffee they are about to drink, or the shoes they just purchased, to underscore this point. It could be argued that self promotion is one of the main, if not the main, driving force behind the popularity of social networks. If this is true, then enhancements and additions to the features offered by social networks that support self promotion can be expected to attract more members to the network, and, so, be especially valuable. One such addition would be the ability to promote one's successes, accomplishments, and enviable lifestyle (not to mention coffee and shoe purchases), directly to a targeted audience of “social rivals,” exactly the people that one would take great pleasure in surpassing.

In current conventional social networks, there is no support for automatically identifying social rivals among the network's members, nor for facilitating the exchange of self promoting information between them. A conventional social network typically supports and encourages relationships between members who know each other, and who are relatively friendly. Any relationship recorded in a social network between members who just happened to be social rivals, is an accidental byproduct, not a direct feature, and not subject to special recognition, or processing, of the relationship by the social network. Providing a solution to that problem by adding the explicit ability to a social network to automatically find, and relate social rivals, and then to maintain a record of that relationship, would allow a member of a social network to target their self promoting communications and information to the other members of the social network that they would most like to surpass, impress, or demotivate, their social rivals. This kind of joy of self promotion and social “comparison” is not limited to individuals, organizations such as clubs, sports teams, and other such entities, also recognize and form social rivalries. Human psychology is such that the members of those entities, or people who associate themselves with those entities (i.e., “fans”) often take great pride when their entity surpasses its rivals, or when those rivals falter and fail (e.g., in American baseball, when the Boston Red Sox win/lose against the New York Yankees).

In either case, the important attributes of a social rivalry are that rivals be “well matched” in some manner such that their mutual comparison is between plausible competitive or social equals, and, that the rivalry has an underlying motivation that drives the enjoyment of one rival surpassing the other. There's no point in pairing “apples and oranges” in a rivalry or the match becomes meaningless. One rival cannot so clearly outperform the other, or be so different, that the two entities don't recognize each other as being in the same “social space,” and so would not put much value on self promotion and comparison, good or bad. In short, a social rivalry relationship is one in which the two entities involved have much in common (e.g., ardent baseball fans), maybe even enough to suggest potential friendship, but they also have a something that strictly divides them (e.g., Boston Fans vs. New York Fans). For example, consider two people training to run a marathon, one a teenage girl, the other, an adult male recently retired from the military, their backgrounds and experiences are so very different, that it would be unlikely that they would give any credence to comparisons between one another, even if their training schedules and abilities were similar. Social rivalries, however, are not between friends; the rivalry is formed and maintained by some aspect of enmity that exists between the rivals. It is not that the enmity is based on actual “hate,” or that the rivals necessarily consider themselves to be enemies, nor, do the rivals even need to know the identities of each other, it is sufficient for one to consider the other to be worth surpassing, whoever they are. It could be that the source of enmity is the product of history, geography, jealously, contempt, or revenge. For example, consider two other people training to run a marathon, If they have much in common, such as similar ages, lifestyles, and abilities, but one supports a politically contentious issue, while the other is vehemently opposed, the two might recognize the other as social rivals. They may be more likely to take great satisfaction in outperforming the other, perhaps interpreting their success as validation of their political views, or, they might take great disappointment in being surpassed by their rival and vow to do better “next time.”

A large measure of how one perceives their competitive achievements centers on how they compare to others doing the same activity. The level of achievement of others serves as an impartial gauge against which one can obtain unbiased feedback on how well they are doing. For instance, one might think they are training hard for a marathon, but it isn't until they compare their training schedules against those of other people who are also training for a marathon, that they can put their efforts into perspective; even more so if those people are very similar to themselves (e.g., age, sex, history, etc.). It is no different for more subjective activities, one doesn't really know how “good” their stamp collection is until they compare it to one created by someone else.

It is not sufficient to simply find such rivals, to bring interest and satisfaction to members of a social network from their rivalries, it will be necessary to feed the rivalry with a steady exchange of status information on the success, or lack thereof, between rivals. It is hard to take satisfaction from surpassing one's rival, if one has no information on their rival's activities. To facilitate this exchange, the existence of the rivalry needs to be recorded, and maintained.

Current social networks, as they are conceived and implemented, do not support the discovery and maintenance of social rival relationships. They are focused primarily on discovering and maintaining relationships that are strictly positive in nature, such as between friends, family members, and career colleagues. There are some experiments on extensions to social networks to represent strictly negative, explicit “enemy,” relationships, but these are not popular, generally used, or well supported; they tend to be novelties or whimsical explorations. This deficiency limits the utility of existing social networks, and reduces the satisfaction they bring to their members; a solution is needed to address this problem.

There is a body of work in relation to competition in online computer games. These systems have users who compete with each other in a game, this leads naturally to the idea of various processes for matching players with each other to play in a game. Unsurprisingly, these all focus on assessing a player's ability within the context of a game, and then matching them appropriately for game play. For instance Woolf, U.S. Pat. No. 7,849,043, entitled “Matching educational game players in a computerized learning environment,” issued Dec. 7, 2010, Miura et al, U.S. Pat. No. 7,686,690, entitled “Game machine and methods for grouping players into teams participating matchup game,” issued Mar. 30, 2010, Farnham et al, U.S. Pat. No. 7,614,955, entitled “Method for online game matchmaking using play style information,” issued Nov. 10, 2009, O'Kelley, U.S. Pat. No. 7,677,970, entitled “System and method for social matching of game players on-line,” issued Mar. 16, 2010.

There is a body of work in the area of computing a “compatibility score” for users of social networks. These all focus on finding cadidates for strictly “positive” relationships. Not surprisingly, much of that work centers on personal matchmaking or dating for romantic purposes. For instance, Martin et al, U.S. Publication. No. 2009/0307314, entitled “Musical interest specific dating and social networking process,” published Dec. 10, 2009, Leonard, U.S. Pat. No. 8,060,573, entitled “Matching social network users,” issued Nov. 15, 2009, and U.S. Pat. No. 8,117,272, also entitled “ Matching social network users,” issued Feb. 14, 2012, Buckwalter et al, U.S. Pat. No. 6,73,5568, entitled “Method and system for identifying people who are likely to have a successful relationship,” issued May 11, 2004, and Sutcliffe, U.S. Pat. No. 6,052,122, entitled “Method and apparatus for matching registered profiles,” issued Apr. 18, 2000.

A method for determining the (strictly positive) compatibility of users of a social network is discussed in Zhu et al, U.S. Pat. No. 7,451,161, entitled “Compatibility scoring of users in a social network,” issued Nov. 11, 2008, and U.S. Pat. No. 8,150,778, also entitled “Compatibility scoring of users in a social network,” issued Apr. 3, 2012. Also, see Hua et al, U.S. Publication No. 2012/0271722, entitled “Top friend prediction for users in a social networking system,” published Oct. 25, 2012.

Tseng, U.S. Pat. No. 7,756,926, entitled “User created tags for online social networking,” issued Jul. 13, 2010, has an example that shows how users can manually create graphical user interface (GUI) components of a social network to “tag” their relationships with other users.

The idea of representing a strictly negative “enemy” relationship in a social network appears in a number of different sources. The manual identification, and recording, of “enemies” occurs in the Facebook application “EnemyGraph.” Terry, D., “EnemyGraph Facebook Application,” Personal Blog http://www.deanterry.com/post/18034665418/enemygraph. Similarly, the Facebook application “Enemybook” Abelson, J., “New apps put the hate in online networking,” Boston Globe, Oct. 10, 2007. Enemybook web site, http://www.enemybook.org/ discusses how to manually “add people as Facebook enemies to a list,” Similarly, the Facebook applications “Nemesis” AppShopper Web Site, http://appshopper.com/social-networking/nemesis-2, and “Snubster”, Abelson, J., “New apps put the hate in online networking,” Boston Globe, Oct. 10, 2007, allow users to represent strictly negative “enemy” relationships.

The social network “Farcebook” Myers, C., Davis, J., “The Social Network,” Code Irony Blog, http://www.codeirony.com/?p=22, that its developers describe as an “anti-social network for people looking to keep track of their enemies” has been implemented as a self-described parody of the social network Facebook.

The “XML Enemies Network” (“XEN”) Suda, B., Keith, J., “XEN 1.0 relationships meta data profile,” http://xen.adactio.com/, and the “XML Friends Network” (“XFN”) Celik, T., Mullenweg, M., Meyer, E., “XFN 1.1 relationships meta data profile,” http://gmpg.org/xfn/11, are HTML4 Meta data profiles, that provide for the textual representation of negative and positive relationships between people Bendrath, R., “Social Networking with Enemies,” Blog, http://bendrath.blogspot.com/2008/06/social-networking-with-enemies.html. The basic idea is that one can add meta-data to an HTML page that expresses the type of relationship; this then becomes a textual data exchange format for exchanging relationship information.

The Internet news web site Slashdot, includes components of a social network called “The Slashdot Zoo.” This network includes both positive relationships between members of the Slashdot supported community, “friend” and its reverse, “fan,”, and negative relationships, “foe,” and its reverse,“freak” Kunegis, J., Lommatzsch A., Bauckhage, C., “The Slashdot Zoo: Mining a Social Network with Negative Edges,” Proceedings of the 18^{th} international conference on World wide web, ISBN: 978-1-60558-487-4, Association for Computing Machinery, .pp 741- 750, Madrid, Spain, April 2009.

### BRIEF SUMMARY OF THE INVENTION

This invention shows how to generate, and record, relationships in a social network, that are not strictly positive, nor strictly negative in nature, but ones that are likely to include both the likelihood of positive aspects of social compatibility, with the likelyhood of a significant negative social component of enmity, and instinctive dislike. The combination is described as a “social riviary” relationship, and is designed to facilitate social comparisons and communication between users, or other entities, of, or known to, the social network. The utility of generating and recording such relationships is that they tend to induce users to return to the social network to receive information on how they currently compare to their social rival. This kind of feature that draws users to the social network to receive this type of feedback, and promotes loyalty to the network; this in turn increases the membership of the network, and consequently, its commercial value.

### BRIEF DESCRIPTION OF THE SEVERAL VIEWS OF THE DRAWING

FIG. 1. Illustrates an overview of the system architecture.

FIG. 2. Illustrates a flow diagram for finding social rivals for users.

FIG. 3. Illustrates a flow diagram for computing the “Social Rivalry Compatibility Metric” of one user with respect to another.

FIG. 4. Illustrates an example compatibility matrix for the user profile attribute of “Favorite Color.”

FIG. 5. Illustrates an example compatibility matrix for the user profile attribute of “Favorite Pet.”

### DETAILED DESCRIPTION OF THE INVENTION

While this invention is illustrated and described in a preferred exemplary embodiment, the invention may be produced in many different configurations, forms and materials. There is depicted in the drawings, and will herein be described in detail, a preferred exemplary embodiment of the invention, with the understanding that the present disclosure is to be considered as an exemplification of the principles of the invention and the associated functional specifications of the materials for its construction, and is not intended to limit the invention to the preferred exemplary embodiment illustrated. Those skilled in the art will envision many other possible variations within the scope of the present invention.

While the preferred exemplary embodiment described herein implicitly discusses users of social networks as if they were people, this is not intended to restrict the invention specifically to social rivalry relationships between individual physical humans. Such relationships can exist between more abstract entities such as sports teams or other loosely defined social aggregations such as the fans of sports teams, or supporters of a particular political cause. Anyone skilled in the art would be able to envision and implement representations in a social network that would encompass such entities, and make them known to the social network, such that they could be included in social rivalry relationships recorded in the social network. For example, one simple solution in an alternate embodiment would represent sports teams as “users” of the social network, and allow them to be social rivals with other “sport team users” of the network. One skilled in the art would be able to embellish, and distinguish these representations.

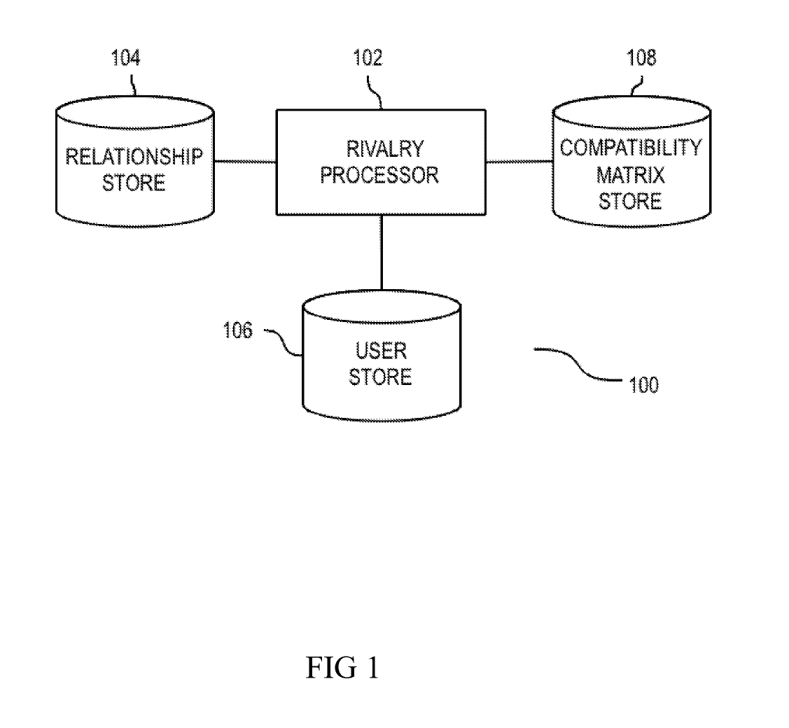

Referring to the drawings, FIG. 1 illustrates a schematic overview of the inventive system architecture 100 that for a particular activity, automatically finds social rivals for members of a social network. The system comprises a Relationship Store 104, User Store 106, a Compatibility Matrix Store 108, and a Rivalry Processor 102.

The Relationship Store 104 maintains a record of the relationships that exist between entities (individuals or groups of users, or external entities such as sports teams) known to the social network, in particular it is able to record that a user has a “social rival” relationship with another user with respect to one or more activities in which both engage. The Relationship Store 104 could be implemented using a graph database, such as Neo4j, which is specifically designed to represent arbitrary relationships between entities, but many other design and implementation choices would be apparent to one skilled in the art.

The User Store 106 maintains information for one or more members of a social network. This information could include the activities in which an individual user participants, as well as other attributes, or information about them. As would be apparent to one skilled in the art, there would be no arbitrary limit on the number or type of attributes that could be recorded. Simple examples could include, but are not limited to, such things as a user's name, and age, as well as many other characteristics such as their likes and dislikes, their favorite color, favorite type of pet, or, more invasively, their political and religious beliefs, the organizations they belong to, or their sexual orientation. As would be clear to anyone skilled in the art, there are many different design choices that could be made for the actual implementation of the User Store 106, this could include, but not be limited to, using a relational database such as MySQL, or simple storage in a file system.

The Compatibility Matrix Store 108 serves the purpose of providing metric values that characterize the potential social compatibility, and lack thereof, between users of the social network. In the preferred exemplary embodiment described here, there are two characterizations that are produced, one that represents the potential for positive social compatibility between two users, while the other represents the potential for negative social compatibility. These values can then combined mathematically to produce a summary metric value that represents the strength of a potential social rival relationship between the two entities.

The Compatibility Matrix Store 108 maintains a collection of matrices, one for each type of attribute allowed in the user profiles stored in the User Store 106. Each matrix records a measurement of the compatibility of two users who have values in their profile for the attribute. This metric is a real number with a value between −1.0 and 1.0, inclusive; where a value of −1.0, indicates that the two users are totally incompatible to the point of dislike or enmity, while a value of 1.0, indicates that the two users are totally compatible; a value of 0.0, indicates that the two users are neutrally compatible with respect to the values of the attribute in their respective profiles. As would be apparent to one skilled in the art, the actual values used, and their range, is subject to design choices; their purpose is to represent a relative spectrum of potential compatibility in accordance with the functioning of the system.

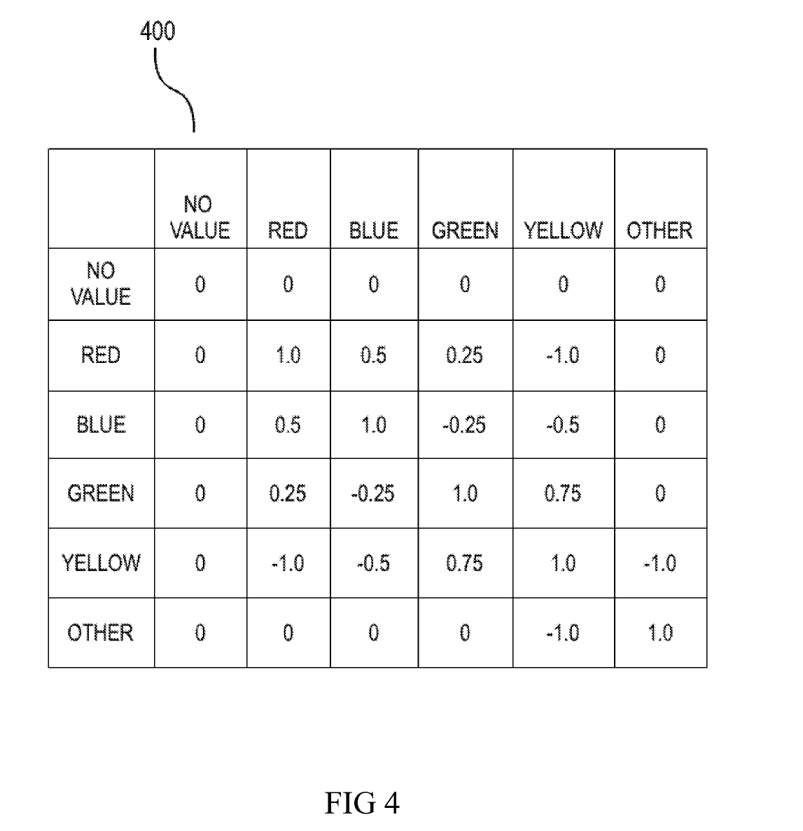

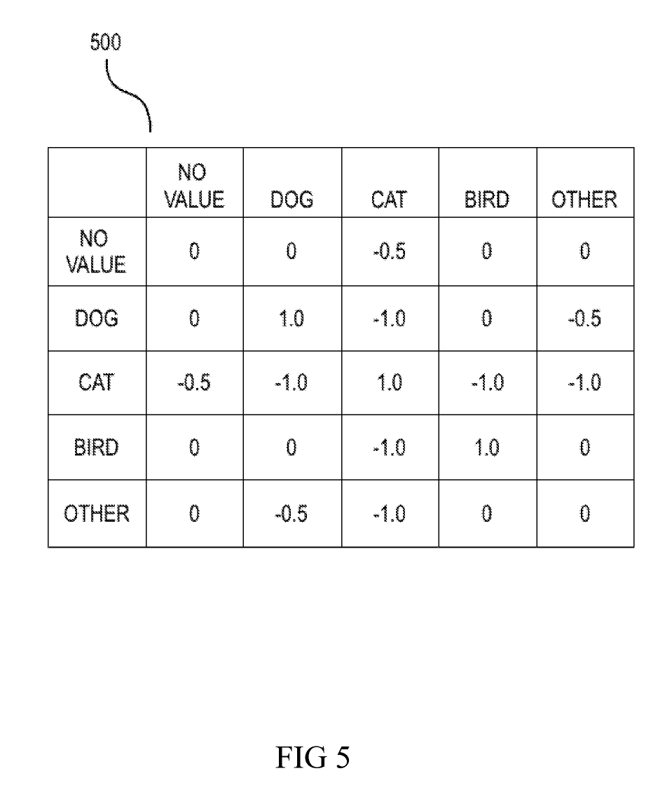

An example of a Compatibility Matrix for the attribute of “Favorite Color” is illustrated in FIG. 4. It shows that if a users favorite color is “red,” then they are compatible with other users whose favorite color is also red with a compatibility value of 1.0, the maximum. It also shows that the same user is compatible with a user who has “blue” as their favorite color with compatibility of 0.5, one who has green with compatibility of 0.25, and one who has yellow with compatibility of −1.0. The later being the minimum compatibility value, indicating that the two users are totally incompatible when it comes to favorite color. A similar matrix for the attribute of favorite pet is illustrated in FIG. 5. It records, for instance, that dog lovers are incompatible with cat lovers (a value of −1.0).

The Compatibility Matrix Store 108 could be implemented as a set of files in a file system, but would typically be implemented using either a relational database such as MySQL, or, a non-relational database such as a key-value store, or other type of “NoSQL” database such as MongoDB. The advantage of the later approach, as would be clear to someone skilled in the art, is a slightly greater ease, and flexibility, in expanding the stored matrix to accommodate the representation of relationships between new attribute values without extensive database schema changes.

The Rivalry Processor 102 incorporates all of the operations required to identify a social rival. It accesses the User Store 106 to iterate through the collection of users of the social network. For each user, it retrieves the activities they participate in, and then for each activity, attempts to find an appropriate social rival for the user for that specific activity. A social rival is identified by finding all of the other users of the social network who also participate in the same activity; these form a candidate pool. For each of the candidates in the pool, the Rivalry Processor 102 computes a metric that represents the value of the candidate as a social rival for the user. In the described preferred exemplary embodiment, this value is called the “Social Rival Compatibility Metric” and is a represented as real number with a value between 0.0 and 1.0, inclusive; a value of 0.0 indicates that the candidate would be a bad choice for the user's social rival (i.e., the user would probably not take great satisfaction from performing better in the activity than the candidate), where a value of 1.0 indicates that the candidate would be a very good choice for playing the role of the user's social rival (i.e., the user is very similar to the candidate, but has one or more attributes that the user would probably intensely dislike, and would probably take great satisfaction from performing in a manner superior to that of the candidate). Again, as explained above, in this preferred exemplary embodiment, the actual numeric value of the metric, and its range, are a design detail that would likely be adapted to a particular implementation by one skilled in the art in accordance with proper functioning of the system.

When the Social Rivalry Compatibility Metric for each candidate has been computed, the values are then examined to select a candidate social rival, or none at all. In one possible alternative embodiment, a simple approach is to simply select the candidate with the largest Social Rival Compatibility Metric value, with provision for breaking ties either by random selection or some other criteria. In other of many possible alternative embodiments, alternative processes for candidate selection will be obvious to one skilled in the art, such as applying a threshold (i.e., minimum value) or performing a more detailed analysis of either the user's and candidate' rival's profile attribute values, or the relationships stored in the Relationship Store 104, or both. For instance, in one possible alternative embodiment, it might be desirable for a user's social rival to be someone that they have no direct, or close, by some measure (e.g., “friend-of-a-friend”), relationships. Various alternative embodiments are possible that would include many different design decisions for implementing this functionality. For instance, one potential alternative embodiment could select a social rival candidate completely at random, or another would select more than one social rival.

In one alternative embodiment, the Social Rival Compatibility Metric would be a Boolean value of either “True” or “False,” with “True” indicating that the candidate is a good social rival, and ‘False” indicating that the candidate is not a good social rival. The values could be obtained directly from the members of the social network themselves by having them manually self-identify their social rivals, or by some other process that produces Boolean values for the metric. The values could even come from an external source of such information such as a database.

The Rivalry Processor 102 accesses the Compatibility Matrix Store 108 to retrieve the attribute value relationship data needed to compute the Social Rivalry Compatibility Metric value. For fast access, once retrieved, these relationships could be stored locally in the Rivalry Processor 102 in either volatile or non-volatile memory.

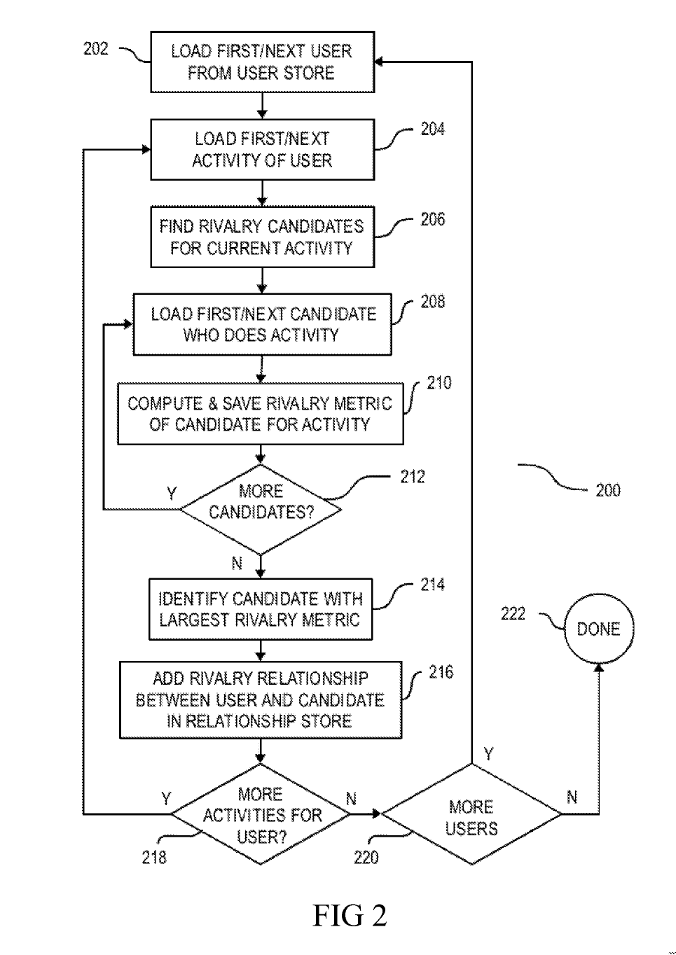

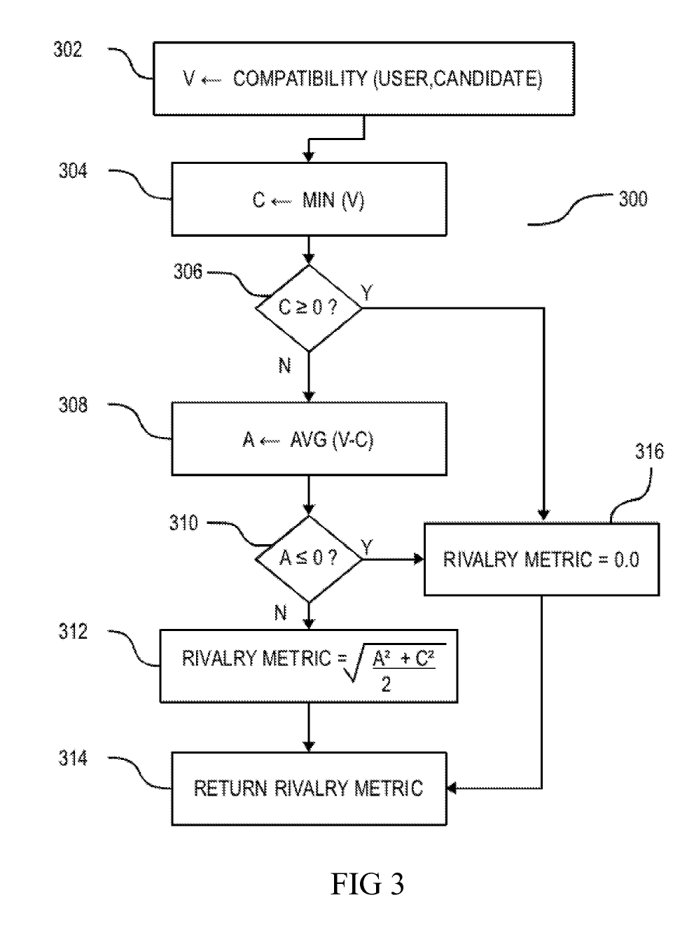

Referring to FIG. 2, a flow diagram 200 illustrates steps for finding social rivals for each user in the User Store 106. The basic intuition behind the flow diagram is that it details how to iterate through the users in the User Store 106, iterate through their activities, find a social rival candidate set, and then iterate through that set, computing the Social Rivalry Compatibility Metric value for each candidate, and then ultimately selecting a social rival from the candidates based upon the values of their associated Social Rivalry Compatibility Metric values, and then generating and recording the social rivalry relationship between the two users in the Relationship Store 104. In step 202, in FIG. 2, the system loads the first user, and their profile, to process from the User Store 106, then in step 204, the system retrieves the first activity from the user profile. In step 206, the system queries the User Store 106 to retrieve all of the users who participate in the activity, excluding the current user being processed, this result forms the set of social rival candidates. In step 208, the system extracts a member of the social rival candidate set, and, then in step 210, it computes the Social Rivalry Compatibility Metric (shortened to “Rivalry Metric” in the flow diagram 200 to conserve space) for the candidate with respect to the current user. The details of the Social Rivalry Compatibility Metric computation of the preferred exemplary embodiment are extracted and detailed in flow diagram 300 in FIG. 3, beginning with step 302. This value is then saved in the Rivalry Processor 102, in either volatile or non-volatile memory, and associated with the candidate rival for future reference. In step 212, the system tests to see if there are further social rival candidates to process, if there are, then the processing flow returns to step 208 to process the next social rival candidate. When all of the social rival candidates have been processed in this manner such that their Social Rivalry Compatibility Metric values have been computed, and retained, the system proceeds on to step 214, where the candidate with the largest Social Rivalry Compatibility Metric value is determined from the set of saved scores, and identified as the new social rival for the current user for the current activity. As discussed previously, one skilled in the art could easily identify alternative variations on selecting the social rival from the social rival candidates, including requiring the metric value to be larger than some threshold, selecting multiple candidates, selecting candidates at random, or even selecting no candidate at all. In step 216, the Rivalry Processor accesses the Relationship Store 104, and records the new relationship between the current user and the new social rival for the current activity. Once recorded, the flow continues on to step 218, where it is determined if there are more activities for the current user to process, if so, then flow returns to step 204, where the next activity to process is selected, and the candidate selection processing iterates; however, if all of the activities have been processed for the current user, then processing flow continues on to step 220, where the system determines if there are any more users to process; if so, then flow returns to step 202, where the next user to process is identified, and user processing iterates. If, at step 220, all of the users have been processed, then flow continues directly to step 222, and the processing is complete.

In one of several possible alternative embodiments, the partitioning of users by the activities they participate in, such that social rivals are paired by activity, could be compressed such that all users are considered to participate in a single activity, for example, simple membership in the social network could be considered to be an “activity,” such that the partitioning by activity step is rendered moot. One skilled in the art would easily be able to implement an alternative embodiment that functioned in accordance with that design choice.

Referring to FIG. 3, a flow diagram 300 illustrates the processing that computes the social rivalry metric for a social rival candidate with respect to a given user, this is the value used in step 210, in FIG. 2. The first step 302 is to extract a set of compatibility measures from a set of Compatibility Matrices retrieved from the Compatibility Matrix Store 108. This is accomplished by matching attributes in the profiles of the user and the candidate, to determine the set of Compatibility Matrices (one for each attribute), and then using their respective attribute values to index into the appropriate Compatibility Matrices and retrieve compatibility measure values for the value combinations. The result is a set of numeric values labeled “V” in step 302. This set is examined in step 304 to find the minimum value it contains, this value becomes the Conflict Measure (shortened to “C” in the flow diagram 300 to conserve space) in step 304. This value is tested in step 306, if it is negative (i.e., not zero or positive), then flow proceeds to step 316 where the Social Rivalry Compatibility Metric (shortened to “Rivalry Metric” in the flow diagram 300 to conserve space) value is set to zero (0.0), and then flow proceeds directly to step 314, where the Social Rivalry Compatibility Metric value is returned. The intuition behind this assignment is that if two users do not have any conflicts (i.e., no negative compatibility measures), then they would not be good social rivals. If, in step 306, the Conflict Measure, is negative, then flow proceeds to step 308, where the Affinity Measure (shortened to “A” in the flow diagram 300 to conserve space) is computed. This value is produced by removing the Conflict Measure (C) from the set of compatibility measures, V, determined in step 302, and then computing the average of the remaining values in the set V. Processing flow then proceeds to step 310, where the value of the Affinity Measure (A) is tested; if it is not positive, then processing flow proceeds to step 316 where the value of the Social Rivalry Compatibility Metric is set to 0.0, and then on to step 314 where it is returned. The intuition behind this is similar to that for step 306 in that if there is no affinity between users there isn't a basis for a rivalry. If the value of the Affinity Measure is positive, then processing flow proceeds to step 312 where the Social Rivalry Compatibility Metric value is computed. This computation essentially normalizes the length of a two-dimensional vector from the origin of a Cartesian (i.e. “XY”) plane to a point defined by using the values of the Affinity Measure and the Conflict Measure as the X and Y values of the point, see Equation 1. This produces a positive value for the Social Rivalry Compatibility Metric between 0.0 and 1.0, inclusive.

$$Social Rivalry Compatibility Metric ( A , C ) = \sqrt{\frac{{A}^{2} + {C}^{2}}{2}} \qquad ( 1 )$$

The computation of the Social Rivalry Compatibility Metric has a multitude of potential variations that would be obvious to one skilled in the art. For instance, of the many possible alternative embodiments, one could include other metrics such as the number of attributes, different “weighting” of compatibility measures based on attribute, more sophisticated statistics, or any of many other design decisions, obvious to one skilled in the art, that produces an alternative approach to producing a value.

When the social rival relationship is recorded in the Relationship Store 104, step 216, FIG. 2, it does not necessarily need to be configured to expose the identifies of the two social rivals to each other, or to anyone else. The visibility of the social rival relationship recorded in the Relationship Store 104 could be configured to be “anonymous,” or even be “hidden” to be exposed later.

Additionally, in some of many potential alternative embodiments, information about the entities in the social rival relationships, independent of the exposure of their respective identities, could be exchanged in an ongoing basis between two, or more, rivals. This is not currently a feature of any known social network as the conventional purpose of known social network implementations is to facilitate interaction between entities who are aware of each others identity. For instance, family members, friends, schoolmates, work or career colleagues. Some social networking implementations targeted at romantic matching may initially suppress detailed identity information when first introducing potential dating partners, but they do not do this on an ongoing basis, doing so would amount to automated “stalking” and be counter to the interests of the target being stalked, and the legal and commercial interests of the social network itself, so that example teaches against ongoing anonymous information exchange. In an alternative embodiment of this invention, the ongoing information exchange, without the specific and accurate identity of the social rivals, is a feature of the social network in which participants of a rivalry both benefit and willingly participate.

As would be obvious to one skilled in the art, information exchange mechanisms in existing social network implementations would suffice, and others easily envisioned, and there would be no arbitrary limits on the type of information that could be exchanged, including any qualitative, subjective, quantitative or abstract information and values. These could include, but not be limited to, such things as personal information stored in the User Store 106, images or video of a social rival, or others, contact information, and statistics about the rival. An example of the later case could be things like data on training sessions such as how often or fast one ran or swam particular distances, or how much weight one can lift (e.g., how much one can bench press). They could also include measurements of things like the weight of a rival, or the size of the tires on their automobiles. These statistics need not be limited to measurements of physical quantities, for instance, an abstract value such as the net worth of an individual could be exchanged. Similarly, there would be no restrictions or limits on the means for communicating between social rivals, including using networked computers, mobile phones or specialized applications for smart phones, advanced watches, or augmented reality display devices. The basic idea is that a steady, on going, stream of information on the progress of social rivals to each other, and possibly others, would be sent to the devices to track the progress of the rivalry in real-time.

The motivation for the exchange of information is that it helps facilitate a rivalry. For instance, if one knows that their social rival is training harder (e.g., running more distance, more often), they might be motivated to train harder than their social rival, and be motivated to use the social network to inform one's social rival, or rivals, of one's superior effort and performance.

In one of several possible alternative embodiments, the ability to manipulate and manage the generation and recording of social rivalry relationships would be part of the implementation. For instance, the existence of a social rival relationship might be hidden by the social network and require the payment of a monetary fee to enable exposure and participation by the social rivals. For instance, this fee could be bundled as part of a membership level in the social network.

In one of several possible alternative embodiments, the management of social rival relationships would be possible. Management functions would include allowing users to opt out of such relationships, request new relationships, delete old ones, or alter their attributes (e.g., removing anonymity from a relationship). Management functions would also include querying the relationships to produce summaries or listings that might used for display purposes, or as the input to additional processing such as mathematical analysis. These operations and their implementation, likely using a standard relationship database, would all be obvious to one skilled in the art.

A system and method has been shown in the above embodiments for the effective implementation of an electronic system to identify users of a social network who would make social rivals for each other, generating that relationship, and then recording the relationship in the social network. Such a relationship can be anonymous and involve an ongoing exchange of information between parties. While various embodiments have been shown and described, it will be understood that there is no intent to limit the invention by such disclosure, but rather, it is intended to cover all modifications and alternative constructions falling within the spirit and scope of the invention, as defined in the appended claims. For example, the present invention should not be limited by software/program computing environment, specific computing hardware. In addition the specific chosen computation methods are representative of the preferred exemplary embodiment and should not limit the scope of the invention.

The present invention can be implemented locally on a single PC, connected workstation (i.e. networked LAN) across extended networks such as the Internet or using equipment (RF, microwaves, infrared, photonic, etc.) The above described functional elements are implemented in various computing environments. For example, the present invention may be implemented on a convention IBM PC©, Macintosh©, UNIX©, or equivalent, single, multi-modal (e.g. LAN) or networking system (e.g., Internet, WWW), or Cloud Computing. All programming, GUIs, display panels and data related thereto are stored in computer memory, static or dynamic, and may be retrieved by the user in any of: conventional computer storage, display, and/or hard copy (i.e., printed) formats. The programming of the present invention may be implemented by one of skill the art of programming.

What is claimed is:

1. A method to be performed by a general purpose computer for operating a social network comprising the steps of:
generating one or more social rival relationships between a plurality of entities known to the social network; and
recording one or more social rival relationships between the plurality of entities known to the social network.

2. The method of claim 1, further comprising the step of:
generating one or more social rivalry compatibility metric values between the plurality of entities known to the social network.

3. The method of claim 2, wherein the generated one or more social rival relationships between a plurality of entities known to the social network are generated in accordance with the social rivalry compatibility metric values.

4. The method of claim 3, wherein said accordance is that a given metric value is the largest such value

5. The method of claim 3, wherein said accordance is that a given metric value is greater than a threshold value.

6. The method of claim 3, wherein said accordance is that the metric value is Boolean True.

7. The method of claim 2, wherein said generated social rivalry compatibility metric values are obtained by querying one or more entities known to the social network.

8. The method of claim 2, wherein said generated social rivalry compatibility metric values are obtained by computation.

9. The method of claim 8, wherein said computation combines social affinity compatibility metric values with social incompatibility metric values.

10. The method of claim 1, wherein the one or more recorded social rival relationships between a plurality of entities known to the social network are anonymous,
whereby, the identities of one or more of the plurality of entities known to the social network in the one or more recorded social rival relationships between the plurality of entities known to the social network are not exposed to the one or more entities of the plurality of entities known to the social network who are recorded in the same social rival relationships.

11. The method of claim 1, further comprising the step of:
exposing information about one or more of the plurality of entities known to the social network, to one or more of the one or more entities of the plurality of entities known to the social network in the same recorded social rival relationships.

12. The method of claim 11, wherein the exposure of information proceeds in an ongoing manner.

13. The method of claim 11, wherein the information exposed includes still and moving images with accompanying audio, text, data or statistics.

14. The method of claim 11, wherein the information exposed includes the identities of one or more entities in the one or more recorded social rival relationships between a plurality of entities known to the social network.

15. The method of claim 12, wherein the ongoing exposure of information is accomplished using a communications device.

16. The method of claim 15, where in the communications device is a mobile telephone, watch, or augmented reality display.

17. The method of claim 1, further comprising the step of:
exposing the existence of the one or more recorded social rivalry relationships between the plurality of entities known to the social network.

18. The method of claim 1, further comprising the step of:
making the one or more of the one or more recorded social rivalry relationships between a plurality of entities known to the social network part of the result of a query of the one or more recorded social rivalry relationships between a plurality of entities known to the social network.

19. The method of claim 1, further comprising the step of:
performing mathematical analysis of the set of the one or more recorded social rivalry relationships between a plurality of entities known to the social network.
